(19) United States
(12) Patent Application Publication
(10) Pub. No.: US 2014/0322410 A1
(43) Pub. Date: Oct. 30, 2014

(54) BEVERAGE BREWING DEVICE

(71) Applicants: Najma Khan, Oakland, CA (US); Michael Anthony Ronzoni, San Francisco, CA (US); Chia-Hsin Sung, San Francisco, CA (US); Richard W. Benner, San Martin, CA (US)

(72) Inventors: Najma Khan, Oakland, CA (US); Michael Anthony Ronzoni, San Francisco, CA (US); Chia-Hsin Sung, San Francisco, CA (US); Richard W. Benner, San Martin, CA (US)

(21) Appl. No.: 13/873,054

(22) Filed: Apr. 29, 2013

(51) Int. Cl. A47J 31/36; A23F 5/26; A47J 31/40

(52) U.S. Cl. CPC A47J 31/36; A47J 31/407; A23F 5/262
USPC 426/433; 99/297; 99/295

(57) ABSTRACT

To make espresso, a plunger forces heated liquid from a plunger cylinder to a coffee container. The resulting brewed liquid is allowed to pass through an expansion pressure relief valve. The expansion pressure relief value maintains a pressure sufficient for brewing espresso as force on the plunger forces the liquid to flow through the coffee container and through the expansion pressure relief valve.

### BACKGROUND

Beverages, such as coffee and tea, may be brewed in various ways, such as boiling, steeping and pressurized steeping.

Espresso is a concentrated beverage brewed by forcing a small amount of pressurized and nearly boiling water through finely ground dark-roast aromatic coffee beans. Espresso usually has a thicker consistency than coffee brewed by other methods. The pressurized brewing process concentrates flavors and chemicals. Espresso also has a higher concentration of suspended and dissolved solids. As a result of the pressure used when brewing espresso, crema forms. Crema is a polyphasic colloidal foam with a creamy texture. Other drinks, such as cappuccino, mocha, macchiato, americano and latte use espresso as a base.

Typically, it has been assumed that optimum espresso extraction is obtained by pumping water heated to about 92° C. through a cake of ground coffee at a fixed 9 bar of pressure to produce around 30 ml of espresso in about 25 seconds. While exact values vary, the one constant in conventional thinking has been fixed pressure. Profiling is an emerging area in specialty coffee. The essence of profiling is to not accept conventional parameters, but to search for alternative pressure (both fixed and variable) and timing combinations to produce the best possible espresso extraction from a particular coffee. For example, advocates of profiling argue that 9 bar is not necessarily the optimum pressure for all coffee blends and they suggest that 25 seconds is not always optimal extraction time.

### BRIEF DESCRIPTION OF THE DRAWINGS

FIG. 1 shows an exploded view beverage brewing device in accordance with an embodiment.

FIG. 2 shows a fully assembled beverage brewing device in accordance with an embodiment.

FIG. 3 shows a sectional view of the beverage brewing device shown in FIG. 2 in accordance with an embodiment.

FIG. 4 shows additional detail of the beverage brewing device shown in FIG. 3 in accordance with an embodiment.

FIG. 5 shows a sectional view of a beverage brewing device having an espresso cup adapter in accordance with an embodiment.

FIG. 6 and FIG. 7 show an electronic component with a heating element in accordance with an embodiment.

FIG. 8 and FIG. 9 show an electronic component with a froth component in accordance with an embodiment.

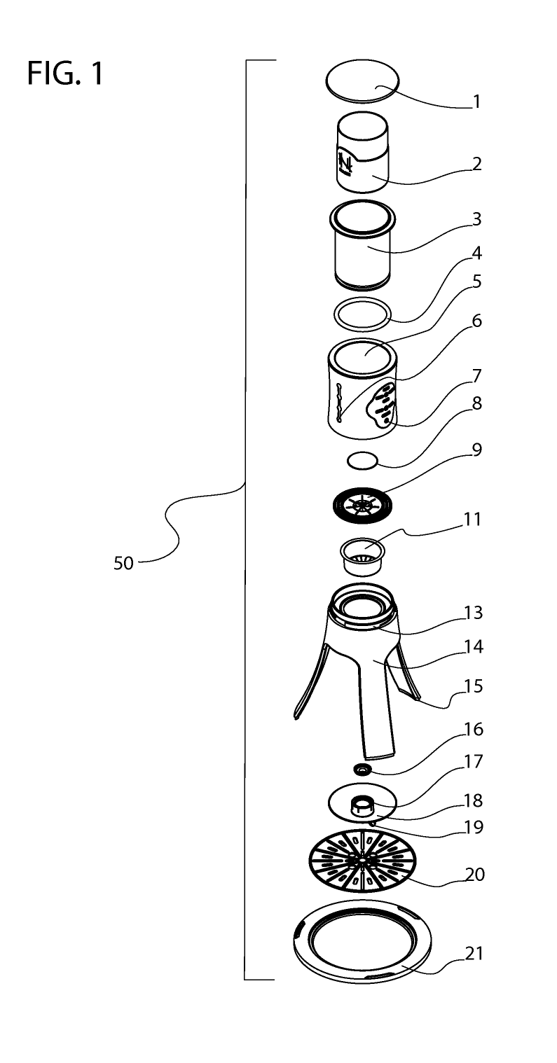

### DESCRIPTION OF THE EMBODIMENT

A beverage brewing device 50 includes a removable plunger cap 1, a collection cup 2, a high pressure plunger 3 and a plunger gasket 4. Collection cup 2 may be personalized, for example, with a logo. For example beverage brewing device 50 is useful for brewing espresso, coffee and other beverages. Allowing for the storage of collection cup 2 within high pressure plunger 3 is a convenience and space saving feature of beverage brewing device 50. When beverage brewing device 50 is transported, collection cup 2 is readily available to be placed on a perforated drip tray 20, in position to receive a beverage from a dual pour spout 19.

A doubled walled plunger cylinder 5 functions as both a plunger cylinder and a carafe. Doubled walled plunger cylinder 5 includes a top liquid volume graduation window 6 and textured grips 7. Top liquid volume graduation window 6 also functions as a color changing temperature indicator.

When brewing espresso or another beverage, hot liquid, typically water, is placed within double walled plunger cylinder 5. The user can use top liquid volume graduation window 6 to monitor the fluid level and liquid temperature within doubled walled plunger cylinder 5. High pressure plunger 3 is used to compress the hot liquid within doubled walled plunger cylinder 5. Liquid flows through and out of doubled walled plunger cylinder 5, past a flapper valve with nipple anchor 8 that is located on top of a condensing shower head 9. Shower head 9 includes a gasket. The hot liquid passes through perforations in shower head 9 and is directed through coffee contained in a brewing adapter, such as an espresso cup adapter 11.

When an espresso is being brewed in an adapter reservoir 22 (shown in FIG. 4), a brewing adapter, is located under shower head 9. For example, an espresso capsule (not shown) within an espresso cup adapter 11 is placed under shower head 9 to directly receive hot pressurized liquid. Ground coffee beans or another brewing mixture are stored within the espresso capsule. Alternatively, to make coffee instead of espresso, an appropriate coffee capsule adapter 12, such as a K-Cup® adapter 12, is used instead of espresso cup adapter 11. For example, a suitable capsule is placed within coffee capsule adapter 12 and under showerhead 9 (see FIG. 4). The coffee capsule may or may not be disposable.

While brewing espresso, substantially elevated pressure is maintained, by the user applying force to plunger 3, as water passes through espresso cup adapter 11. For example, a bottom piece 14 that includes tripod legs and an attachment mechanism 13 receives double walled plunger cylinder 5 and creates high pressure utilizing sealing gaskets on shower head 9. The sealing gaskets are able to withstand the high pressure that is generated by high pressure plunger 43. The pressure is released by brewed liquid exiting an expansion pressure release valve (EPRV) 16. A multi-purpose liquid exit apparatus includes a safety bowl section 18 that secures EPRV 16 with an EPRV lock 17.

EPRV 16 is a composed of a soft malleable material, such as silicon or rubber. Hardness of EPRV 16 is selected to control the amount of pressure maintained as a user applies pressure to plunger 43. For example, hardness of EPRV is selected so that EPRV 16 will withstand 9 Bar (132.3 pounds per square inch) pressure before releasing liquid. Once 9 Bar pressure is exceeded, brewed beverage exits through EPRV 16.

For example, EPRV 16 assures that pressure sufficient for brewing espresso is maintained as liquid passes through espresso cup adapter 11 in response to force placed on plunger 3. Typical pressure for brewing espresso is between 9 Bar and 11 Bar. Other pressures may be used. To regulate pressure, brewed coffee is released through EPRV 16 and out through dual spout 19 and into collection cup 2 or some other container supported by perforated drip tray 20 and located under dual port spout 19. For example, EPRV 16 can be interchangeable allowing for EPRVs of different hardness to be used, to accommodate brewing of beverages that require different pressure during brewing.

A base 21 is for spilled liquid to collect and serves as a location for attaching tripod legs. A tong and groove joint 15 at the bottom of each tripod leg holds the tripod leg securely to base 21.

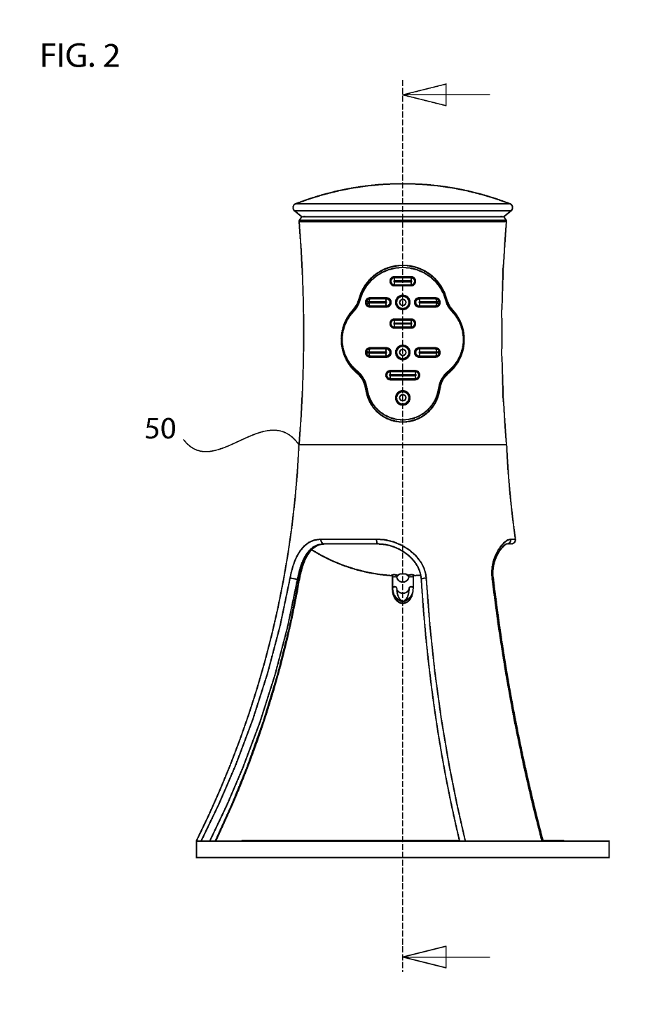

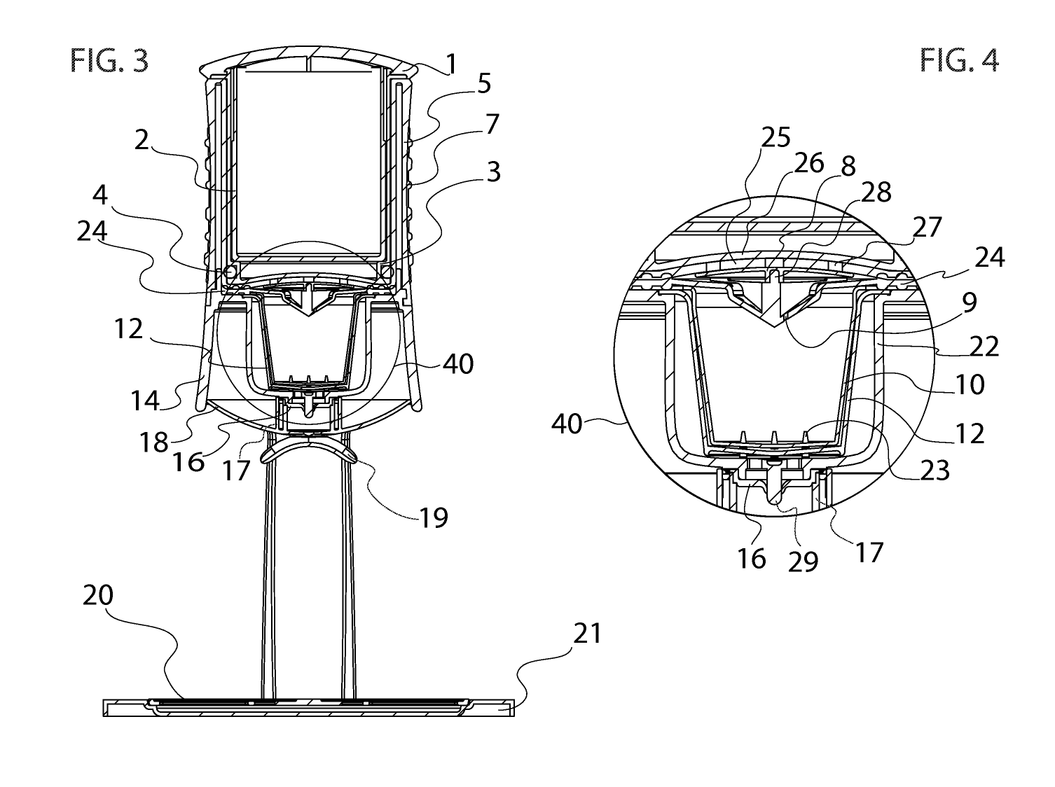

FIG. 2 shows beverage brewing device 50 fully assembled with coffee capsule adapter 12. FIG. 3 is a sectional view of beverage brewing device 50. FIG. 3 shows safety bowl section 18 of the multi-purpose liquid exit apparatus securing EPRV 16 with EPRV lock 17 while allowing coffee to flow out of dual spout 19. Coffee capsule adapter 12 is shown within an adapter reservoir 22 that is integrated as part of bottom piece 14.

In FIG. 3, an area is designated by a circle 40. A detailed view of the area designated by circle is shown in FIG. 4. Carafe 5 is shown to have a concave bottom 25 that includes liquid transfer holes 27. High pressure plunger 3 is shown to have a concave bottom 26. Piercing needle valves 23 are placed so as to be able to pierce through cups or capsules. Placed within coffee capsule adapter 12. There is a sufficient number of piercing needle valves, for example four, so that the liquid reaches all coffee beans within a capsule 10.

A high compression gasket 24 is co-molded to shower head 9 and seals internal adapter cups such as espresso cup adapter 11 or Coffee capsule adapter 12. EPRV 16 is shown to have a sealing step 29. Also an anchor 28 for flapper valve with nipple anchor 8 is shown.

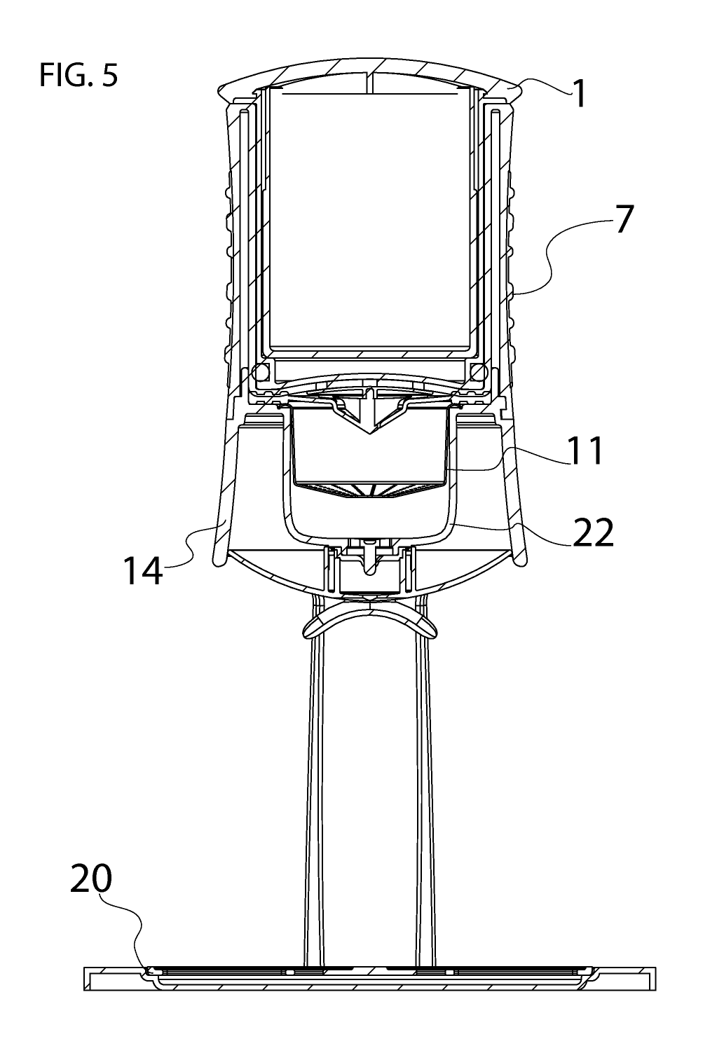

FIG. 5 shows a sectional view of beverage brewing device 50 fully assembled with espresso adapter cup 11 in use within adapter reservoir 22.

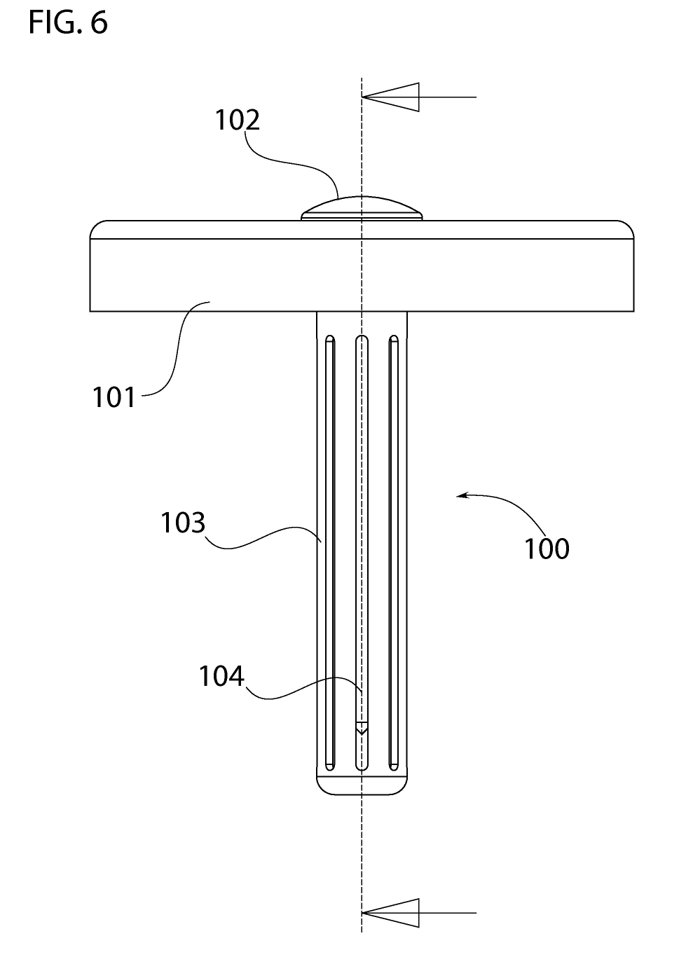

FIG. 6 shows a heater 100. Heater 100 includes a push button on/off power switch 102, a heating element rod 104 and a heating element isolation shell 103 that prevents against a user touching a hot element rod.

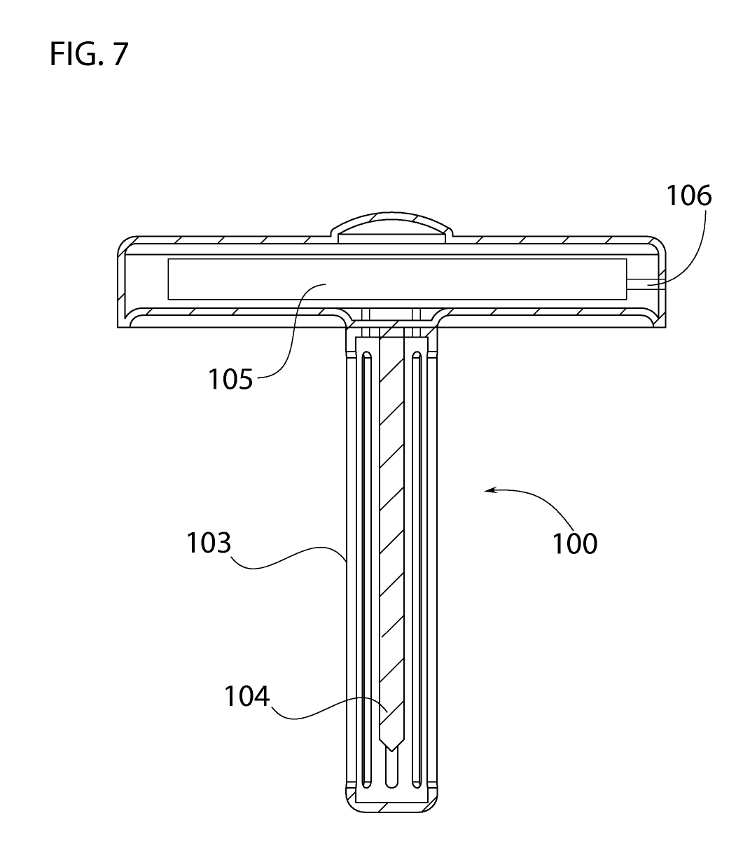

FIG. 7 shows a cross-sectional view of heater 100. An electronic housing component 101(shown in FIG. 5) encloses a rechargeable battery pack 105 and an alternate current (NC) outlet 106 that functions as an alternative power source and a source of power for battery charging. For example, the battery is a high voltage and high amperage lithium-ion battery pack. Electronic housing component 101 will control charging, discharging, temperature sensing, thermal interrupt and voltage regulation.

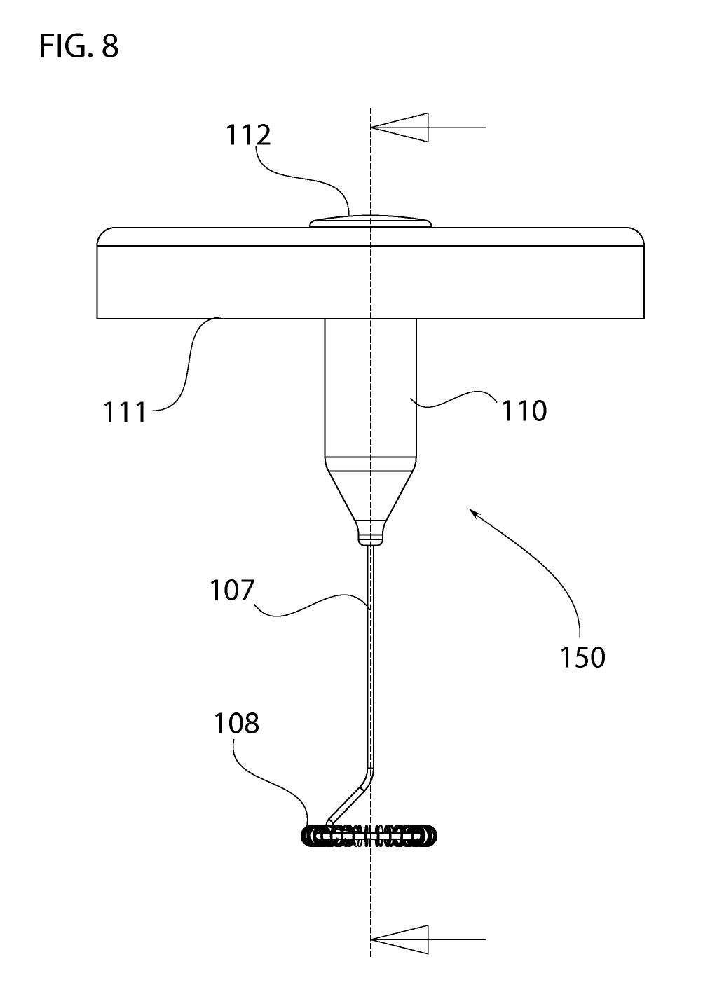

FIG. 8 shows a frother 150. Frother 150 includes a battery-life indicating push button on/off power switch 112, a frother shaft 107 and a frother component 108.

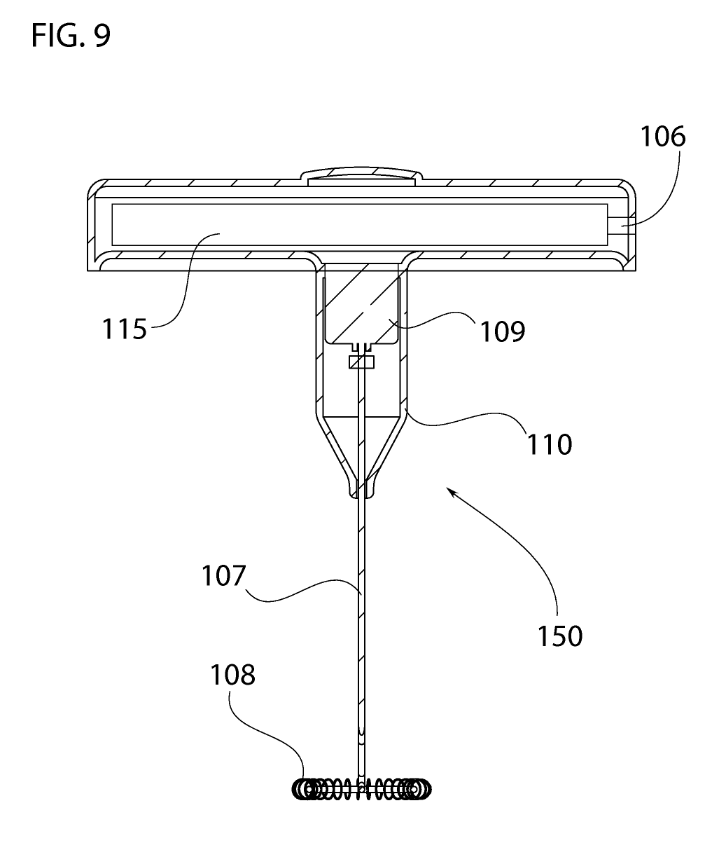

FIG. 9 shows a cross-sectional view of frother 150. An electronic housing component 111 (shown in FIG. 8) encloses a rechargeable battery pack 115 and an alternate current (NC) outlet 116. A spin motor 109 is within a spin motor housing 110. Spin motor 109 operates, for example, at ?? RPMs.

Housing component 101 and housing component 111 are detachable and interchangeable. For example, spin motor housing 110 is detachable from housing component 111 and attachable to housing component 101. Likewise, heating element isolation shell 103 with heating rod 104 are detachable from housing component 101 and attachable to housing component 111. This allows a single battery housing component to be connected to form either a heater, for example, used to heat water within double walled plunger container 5 or to a frother, for example, used to froth milk, etc., for a latte or a cappuccino. This allows for the ability to prepare an espresso, a latte or a cappuccino using battery and manual power only. No electrical outlet is required.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A beverage brewing device, comprising:
a plunger;
a plunger cylinder;
a coffee container; and, an expansion pressure relief valve, the expansion pressure relief value maintaining a pressure sufficient for brewing espresso as force on the plunger forces the liquid to flow through the coffee container and through the expansion pressure relief valve.

2. A beverage brewing device as in claim 1 wherein the plunger houses a collection cup.

3. A beverage brewing device as in claim 1 wherein the coffee container is a coffee capsule adapter having a plurality of piercing needle valves.

4. A beverage brewing device as in claim 1 wherein the expansion relief valve is held in place by an expansion relief valve lock.

5. A beverage brewing device as in claim 1, additionally comprising a heater for heating liquid within the plunger cylinder or other container, the heater being powered by a battery or an alternate current (AC) power source.

6. A beverage brewing device as in claim 1, additionally comprising a battery powered heater for heating liquid within the plunger cylinder, a power supply portion of the battery powered heater being detachable from a heater portion of the battery powered heater and being attachable to a frother accessory.

7. A method for making espresso, comprising:
using a plunger to force heated liquid from a plunger cylinder to a coffee container; and, allowing resulting brewed liquid to pass through an expansion pressure relief valve, the expansion pressure relief value maintaining a pressure sufficient for brewing espresso as force on the plunger forces the liquid to flow through the coffee container and through the expansion pressure relief valve.

8. A method as in claim 7 additionally comprising:
housing a collection cup in the plunger.

9. A method as in claim 7 additionally comprising:
using a plurality of piercing needle valves to pierce a coffee within a coffee capsule adapter, functioning as the coffee container.

10. A method as in claim 7 additionally comprising:
holding the expansion relief valve in place by an expansion relief valve lock.

11. A method as in claim 7, additionally comprising heating liquid within the plunger cylinder using a battery powered heater.

12. A method as in claim 7, additionally comprising:
heating liquid within the plunger cylinder using a battery powered heater; and,
using a power supply portion of the battery powered heater to power a frother accessory.
